(19) United States
(12) Patent Application Publication
(10) Pub. No.: US 2014/0099102 A1
(43) Pub. Date: Apr. 10, 2014

(54) SYSTEMS AND METHODS FOR STATISTICAL SHARING IN OPTICAL COMMUNICATIONS NETWORKS

(71) Applicant: FUJITSU LIMITED, Kanagawa (JP)

(72) Inventors: Xi Wang, Murphy, TX (US); Qiong Zhang, Plano, TX (US); Inwoong Kim, Allen, TX (US); Paparao Palacharla, Richardson, TX (US); Motoyoshi Sekiya, Richardson, TX (US)

(73) Assignee: Fujitsu Limited, Kanagawa (JP)

(21) Appl. No.: 13/890,728

(22) Filed: May 9, 2013

Related U.S. Application Data
(60) Provisional application No. 61/711,088, filed on Oct. 8, 2012.

(51) Int. Cl. H04Q 11/00

(52) U.S. Cl. CPC H04Q 11/0005
USPC 398/25; 398/48; 398/50

(57) ABSTRACT

A method of statistical sharing in an optical communications network is disclosed. The method includes identifying a peak transmission rate and a base transmission rate for each of a plurality of client interface cards of an optical node.

The method further includes provisioning a set of universal transceivers of a plurality of universal transceivers for a particular client interface card of the plurality of client interface cards such that the combined bandwidth of the set of universal transceivers is greater than or equal to the base transmission rate of the particular client interface card. The method also includes reserving one or more shared universal transceivers of the plurality of universal transceivers for the particular client interface card, when a transmission rate of the particular client interface card exceeds the base transmission rate of the particular client interface card.

### RELATED APPLICATION

This application claims benefit under 35 U.S.C. §119(e) of U.S. Provisional Patent Application No. 61/711,088, entitled Systems and Methods for Statistical Multiplexing in Circuit Switching WDM Optical Networks and filed on Oct. 8, 2012, which is hereby incorporated by reference in its entirety.

### TECHNICAL FIELD

This disclosure relates generally to communications networks and, more particularly, to statistical sharing in circuit switching optical communications networks.

### BACKGROUND

Telecommunications systems, cable television systems and data communication networks may use optical networks to rapidly convey large amounts of information between remote points. In an optical network, information may be conveyed in the form of optical signals through optical fibers. Optical fibers may include thin strands of glass capable of communicating the signals over long distances with very low loss. An optical communications network may be configured to establish a circuit, from an entry to an exit node, by adjusting optical cross-connect circuits such that a data signal can travel from the entry to the exit node. Optical communications networks may utilize wavelength-division multiplexing (WDM), which is a technology that multiplexes a number of optical carrier signals onto a single optical fiber by using different wavelengths of light. This technique enables bi-directional communications over one strand of fiber, as well as multiplication of capacity.

### SUMMARY

In one embodiment, a method of statistical sharing in an optical communications network is disclosed. The method includes identifying a peak transmission rate and a base transmission rate for each of a plurality of client interface cards of an optical node. The method also includes provisioning a set of universal transceivers of a plurality of universal transceivers for a particular client interface card of the plurality of client interface cards such that the combined bandwidth of the set of universal transceivers is greater than or equal to the base transmission rate of the particular client interface card. The method further includes reserving one or more shared universal transceivers of the plurality of universal transceivers for the particular client interface card, when a transmission rate of the particular client interface card exceeds the base transmission rate of the particular client interface card.

In another embodiment, an optical communications network is disclosed. The optical communications network includes a cross-connect switch, a plurality of universal transceivers communicatively coupled to the cross-connect switch, a switching module communicatively coupled to the plurality of universal transceivers, and a controller communicatively coupled to the cross-connect switch and the switching module. The controller is configured to identify a peak transmission rate and a base transmission rate for each of a plurality of client interface cards of an optical node. The controller is also configured to provision a set of universal transceivers of a plurality of universal transceivers for a particular client interface card of the plurality of client interface cards such that the combined bandwidth of the set of universal transceivers is greater than or equal to the base transmission rate of the particular client interface card. The controller is further configured to reserve one or more shared universal transceivers of the plurality of universal transceivers for the particular client interface card, when a transmission rate of the particular client interface card exceeds the base transmission rate of the particular client interface card.

In yet another embodiment, a non-transitory, computer-readable medium including computer-executable instructions encoded in the computer readable medium is disclosed. The instructions, when executed by the processor, are operable to perform operations including identifying a peak transmission rate and a base transmission rate for each of a plurality of client interface cards of an optical node. The instructions are further operable to, when executed by the processor, perform operations including provisioning a set of universal transceivers of a plurality of universal transceivers for a particular client interface card of the plurality of client interface cards such that the combined bandwidth of the set of universal transceivers is greater than or equal to the base transmission rate of the particular client interface card. The instructions are still further operable to, when executed by the processor, perform operations including reserving one or more shared universal transceivers of the plurality of universal transceivers for the particular client interface card, when a transmission rate of the particular client interface card exceeds the base transmission rate of the particular client interface card.

### BRIEF DESCRIPTION OF THE DRAWINGS

A more complete understanding of the disclosed embodiments and advantages thereof may be acquired by referring to the following description taken in conjunction with the accompanying drawings, in which like reference numbers indicate like features, and wherein:

FIG. 1 is a diagram of an example optical communications network, in accordance with one embodiment of the present disclosure.

FIG. 2 is a diagram of an example optical node, in accordance with one embodiment of the present disclosure.

FIG. 3A illustrates the bandwidth requirement of an example optical communications network configured to provision bandwidth sufficient to accommodate the peak transmission rate of each client system.

FIG. 3B illustrates the bandwidth requirement of an optical communications network configured to permit only a portion of the client systems to simultaneously transmit at their peak data transmission rate, in accordance with one embodiment of the present disclosure.

FIG. 4 is a flowchart of an example method of statistical sharing in optical communications networks, in accordance with one embodiment of the present disclosure.

### DETAILED DESCRIPTION

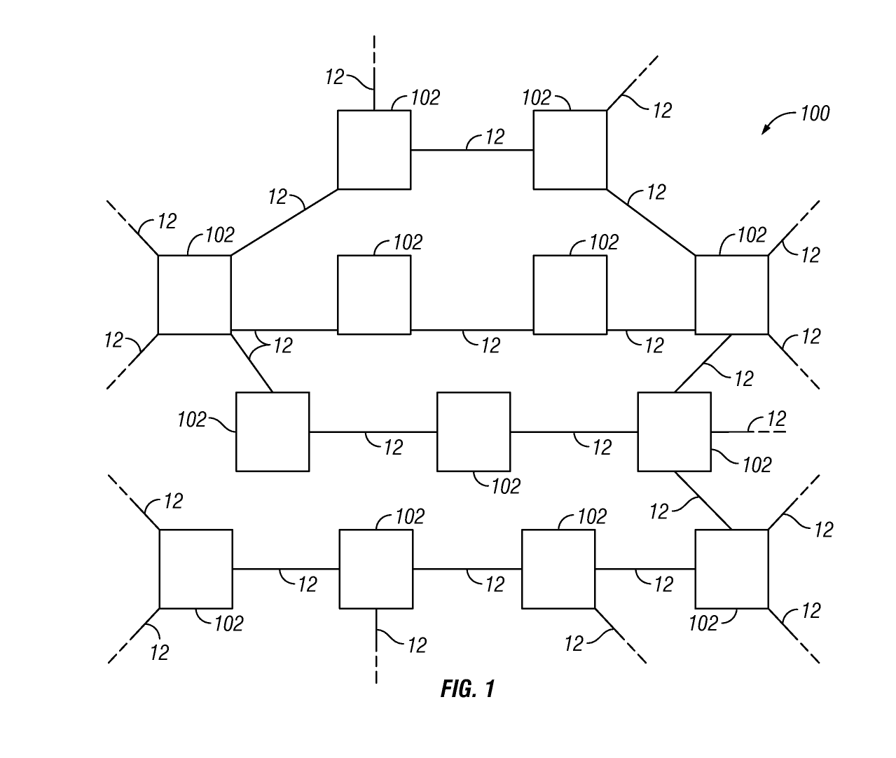

Particular embodiments and their advantages are best understood by reference to FIGS. 1 through 4, wherein like numbers are used to indicate like and corresponding parts.

An optical communications network may be a circuit switching network including a plurality of optical circuits, each of which has a fixed capacity. For example, in a fixed grid optical network, an optical circuit may be provisioned as an end-to-end wavelength light-path with a fixed capacity (e.g., 10, 40, or 100 Gbps). In flexible grid optical networks, an optical circuit may consist of a fixed number of spectrum slots, each with a fixed capacity. Because the capacity of each optical circuit is fixed, the bandwidth provisioned for each optical circuit must be sized based on the peak anticipated bandwidth for the circuit, even though the peak bandwidth is not always used. This disclosure sets forth methods and systems for increasing statistical capacity and/or reducing bandwidth requirements in an optical communications network through statistical sharing.

FIG. 1 is a block diagram of an example optical communications network 100, in accordance with one embodiment of the present disclosure. In certain embodiments, network 100 may be a shared mesh network. Network 100 may include a plurality of network elements 102, each of which may be an optical node. Nodes 102 may be communicatively coupled via one or more transmission media 12 operable to transport one or more signals communicated by nodes 102.

In some embodiments, each node 102 may be operable to transmit traffic directly to one or more other nodes 102 and receive traffic directly from one or more other nodes 102. For example, in the illustrated network 100, each node 102 is coupled to one or more other nodes 102 to create a mesh. Network 100 may, however, include any suitable number of nodes 102 arranged in any suitable configuration. For example, although network 100 is illustrated as a mesh network, network 100 may also be configured as a ring network, a point-to-point network, or any other suitable network or combination of networks. Additionally, network 100 may be used in a short-haul metropolitan network, a long-haul inter-city network, or any other suitable network or combination of networks. Network 100 may represent all or a portion of a short-haul metropolitan network, a long-haul inter-city network, and/or any other suitable network or combination of networks.

Each node 102 in network 100 may include any system, device, or apparatus operable to transmit and receive traffic. For example, each node 102 may include logic (e.g., hardware, software, or a combination of hardware and software) operable to execute instructions and manipulate data to perform operations. Such logic may include, for example, a processor, microprocessor, field-programmable gate array (FPGA), or application specific integrated circuit (ASIC). Node 102 may also include an interface operable to send and/or receive traffic and memory operable to store and facilitate retrieval of information. Memory may include Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding, and/or any other suitable components.

Each transmission medium 12 may include any system, device, or apparatus configured to communicatively couple nodes 102 to one another. For example, transmission medium 12 may include an optical fiber, an Ethernet cable, a T1 cable, copper cable, a WiFi signal, a Bluetooth signal, or any other suitable medium. In some embodiments of the present disclosure, transmission medium 12 may include optical fibers comprised of thin strands of glass capable of communicating signals over long distances with very low loss. Optical fibers may include any suitable type of fiber, such as a Single-Mode Fiber (SMF), Enhanced Large Effective Area Fiber (ELEAF), or a TrueWave® Reduced Slope (TW-RS) fiber.

Network 100 may communicate information or “traffic” over transmission media 12. Traffic may include information transmitted, stored, or sorted in network 100. Such traffic may comprise optical or electrical signals configured to encode audio, video, textual, and/or any other suitable data. The data may be real-time or non-real-time. Traffic may be communicated via any suitable communications protocol, including, without limitation, the Open Systems Interconnection (OSI) standard and Internet Protocol (IP). Additionally, the traffic communicated in network 100 may be structured in any appropriate manner including, but not limited to, being structured in frames, packets, or an unstructured bit stream. For example, traffic may be transmitted in data packets or frames known as Optical Channel Transport Unit (OTU) frames. The OTU frames may include an Optical Channel Data Unit (ODU) signal.

In some embodiments, network 100 may include a management or control plane, as well as a transport plane. The management plane may be used generally for management of the network, while the transport plane may be used generally for transmission of traffic through the network. The transport plane may, however be used to transmit some management information and the management plane may be used to transmit some traffic. Transmissions on the management plane may be managed and/or controlled by a network controller (not expressly shown).

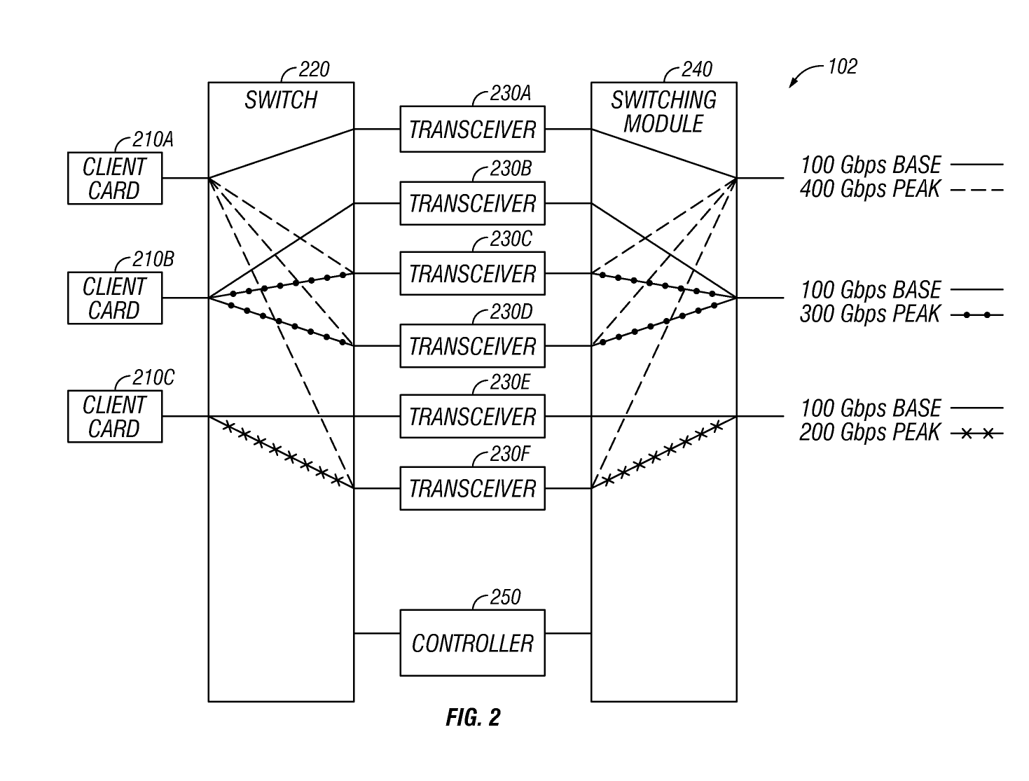

FIG. 2 is a diagram of an example optical node 102 in accordance with one embodiment of the present disclosure. Node 102 may include client interface cards 210, cross-connect switch 220, universal transceivers 230, switching module 240, and node controller 250.

Client interface cards 210 may, for example, be a network interface card configured to facilitate communication between a corresponding client system and optical node 102. As another example, client interface cards 210 may be hardware, software, firmware, or some combination thereof configured to facilitate communication between client systems and node 102. Client systems may be personal computers (e.g., desktop or laptop), tablet computers, mobile devices (e.g., personal digital assistant (PDA) or smart phone), servers (e.g., blade server or rack server), network storage devices, printers, routers, switches, or any other suitable device.

Client interface cards 210 may be communicatively coupled to cross-connect switch 220, which may be an electrical or optical switch configured to facilitate the transmission of data from client interface cards 210 to universal transceivers 230. Switching module 240 may be hardware, software, or some combination thereof configured to block, pass, or redirect optical signals received from universal transceivers 230. For example, in some embodiments, switching module 240 may be a reconfigurable optical add-drop multiplexer (ROADM) that optically switches signals received from universal transceivers 230.

Universal transceivers 230 (also referred to as universal line cards) may be communicatively coupled between cross-connect switch 220 and switching module 240. Each universal transceiver 230 may be configured with a particular data transmission capacity. For example, in the embodiment illustrated in FIG. 2, each universal transceiver 230 may have a bandwidth of 100 Gbps; thus, each universal transceiver 230 may be operable to transmit up to 100 Gbps of data simultaneously. Universal transceivers 230 may be reconfigured to increase the data transmission capacity of each universal transceiver 230 up to a maximum capacity.

Network controller 250 may be any system, device, or apparatus configured to manage and/or control transmissions to and from node 102. For example, controller 250 may be configured to issue commands and/or other signals to manage and/or control data transmissions to and/or from node 102. Controller 250 may include a microprocessor, microcontroller, DSP, ASIC, field programmable gate array (“FPGA”), EEPROM, or any combination thereof. As shown in FIG. 2, controller 250 may be communicatively coupled to cross-connect switch 220 and switching module 240.

Node 102 may be configured to transmit data received by client interface cards 210 through cross-connect switch 220, one or more universal transceivers 230, and switching module 240. In some embodiments, controller 250 may provision particular universal transceivers 230 for the transmission of data received from a client system by a particular client interface card 210. Based on the provisioning of universal transceivers 230, controller 250 may issue commands to cross-connect switch 220 regarding the universal transceivers 230 to which data transmissions from a particular client interface card 210 should be directed. Similarly, in some embodiments, controller 250 may provision particular universal transceivers 230 for the transmission of data received from a different node. For example, controller 250 may be communicatively coupled to the controllers of other nodes of optical communications network 100 and/or a network controller of optical communications network 100 (discussed above with respect to FIG. 1). Based on the characteristics of the incoming data transmissions, controller 250 may issue commands to switching module 240 regarding the universal transceivers 230 to which data transmissions to a particular client interface card 210 should be directed.

As discussed above, in some optical communications networks, an optical circuit may be provisioned with a fixed capacity. Where the capacity of each optical circuit is fixed, each circuit must be sized based on the peak anticipated bandwidth for the circuit, even though the peak bandwidth is not always used. Consider, for example, a client system with a peak data transmission rate of 400 Gbps. To accommodate the peak data transmission rate of such a client system, four universal transceivers 230, each with a bandwidth of 100 Gbps, must be provisioned. When universal transceivers 230 are provisioned for data transmission from a particular client system, and thus a particular client interface card 210, they may not be used to transmit data from other client systems.

In accordance with the teachings of this disclosure, however, node 102 may be configured such that bandwidth is allocated to each client interface card 210, and thus each client system, based on a base data transmission rate (e.g., the rate at which data is routinely transmitted by a client system) instead of the peak data transmission rate (e.g., the maximum rate at which data is transmitted by a client system). For example, one or more universal transceivers 230 may provisioned to each client interface card 210 to accommodate the base data transmission rate of the corresponding client system. The remaining universal transceivers 230 may be shared among client interface cards 210 to accommodate data transmission above the base data transmission rates of the corresponding client systems. In the event the data transmission rate of a particular client system exceeds its data transmission rate, additional bandwidth may be provided by temporarily allocating shared universal transceivers 230 to the corresponding client interface card 210.

Consider, for example, that the client system corresponding to client interface card 210A has a base data transmission rate of 100 Gbps and a peak data transmission rate of 400 Gbps, the client system corresponding to the client interface card 210B has a base data transmission rate of 100 Gbps and a peak data transmission rate of 300 Gbps, and the client system corresponding to client interface card 210C has a base data transmission rate of 100 Gbps and a peak data transmission rate of 200 Gbps. Each universal transceiver 230 may have a bandwidth of 100 Gbps. A single universal transceiver 230A may be provisioned to accommodate the 100 Gbps base data transmission rate of the traffic on client interface card 210A. Similarly, universal transceivers 230B and 230E may be provisioned to accommodate the 100 Gbps base data transmission rate for the traffic on client interface cards 210B and 210C, respectively.

In the event the data transmission rate for the traffic on a particular client interface card 210 exceeds the base data transmission rate, controller 250 may temporarily allocate a shared universal transceiver 230 to the particular client interface card 210. For example, as shown in FIG. 2, universal transceivers 230C, 230D, and/or 230F may be temporarily allocated to client interface card 210A in the event the data transmission rate for client interface card 210A exceeds its base data transmission rate of 100 Gbps. Because universal transceivers 230C, 230D, and 230F have not been provisioned for client interface card 210A, however, they may be temporarily allocated to client interface cards 210B and/or 210C in the event the data transmission rate for client interface cards 210B and/or 210C exceeds the base data transmission rate. Once the data transmission rate for client interface card 210A returns to level at or below its base data transmission rate, universal transceivers 230C, 230D, and/or 230F may be released and may be available for use by the remaining client interface cards 210, if needed.

By enabling client interface cards 210 to share universal transceivers 230 for data transmissions exceeding the base data transmission rate of each client interface card 210, the statistical capacity of node 102 may be increased. For example, as shown in FIG. 2, node 102 includes six universal transceivers 230, each with a bandwidth of 100 Gbps, providing a total bandwidth of 600 Gbps. If it were necessary to provision bandwidth sufficient to accommodate the peak data transmission rate of the client systems corresponding to each client interface card 210, node 102 would have a capacity of only 600 Gbps and would thus lack the capacity to accommodate traffic from the client systems corresponding to client interface cards 210A, 210B, and 210C, which have a combined peak data transmission rate of 900 Gbps. Where, on the other hand, universal transceivers 230 may be shared among client interface cards 210 to accommodate data transmission above the base data transmission rates of the client systems corresponding to client interface cards 210, the statistical capacity of node 102 may be increased to 900 Gbps, thereby enabling node 102 to accommodate traffic from the client systems corresponding to client interface cards 210A, 210B, and 210C.

Although the client interface cards 210 illustrated in FIG. 2 correspond to client systems having a base data transmission rate of 100 Gbps, the base data transmission rate of a client system may be greater than 100 Gbps. Additionally, although universal transceivers 230 are illustrated as having a bandwidth of 100 Gbps, universal transceivers 230 may have a bandwidth greater than 100 Gbps. Further, although FIG. 2 illustrates universal transceivers 230 being shared by two client interface cards 210 (e.g., universal transceiver 230F shared by client interface cards 210B and 210C), universal transceivers 230 may be shared among more than two client interface cards 210. Where universal transceivers 230 are shared among more than two client interface cards 210, the statistical capacity of node 102 may be increased even further.

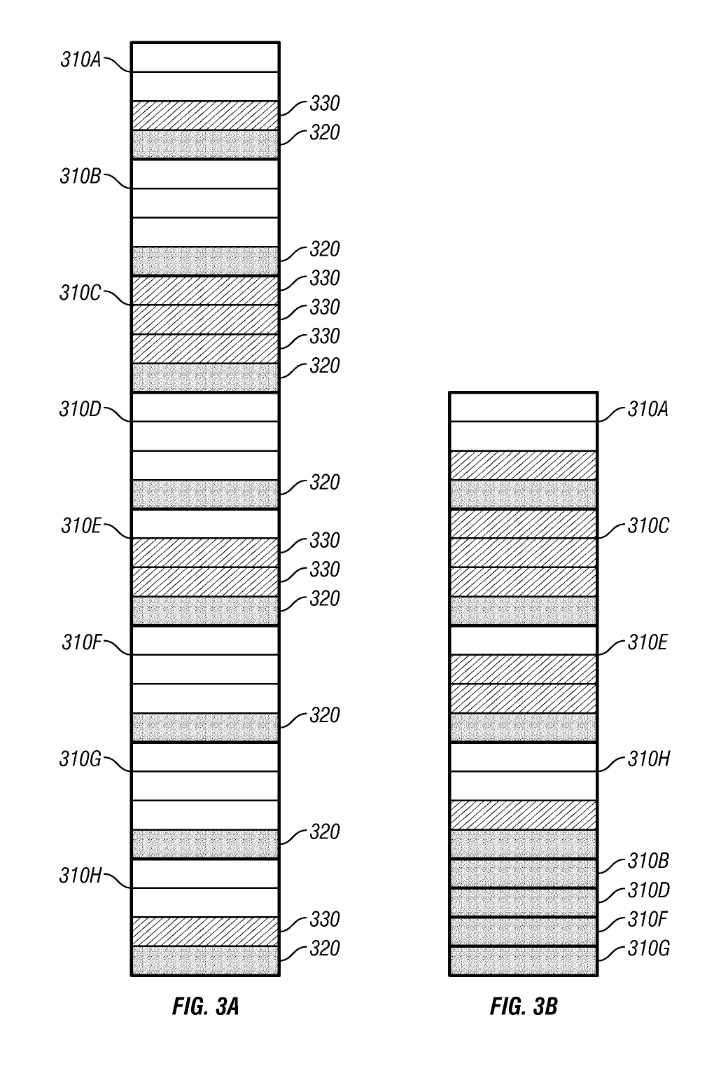

As the statistical capacity of a node increases, the bandwidth requirements of the node may decrease. For example, the bandwidth requirement of a node configured such that client interface cards may share universal transceivers will be less than that of a node configured to provision bandwidth sufficient to accommodate the peak data transmission rate of the client systems corresponding to each client interface card. FIG. 3A illustrates the bandwidth requirement of a node configured to provision bandwidth sufficient to accommodate the peak data transmission rate of client systems corresponding to each client interface card. Each block 310 may represent the bandwidth required to accommodate the peak transmission rate of a client system corresponding to a particular client interface card. In this example, each block 310 is sized to represent the 400 Gbps of bandwidth necessary to accommodate the 400 Gbps peak data transmission rate of the client systems corresponding to each client interface card. To accommodate the peak transmission rate of each client system, the node must have a capacity of 3200 Gbps.

Most of the client systems, however, will not operate at their peak data transmission rate; instead operating at a data transmission rate between their base and peak data transmission rates. For example, the shaded bars within each block 310 may represent the bandwidth necessary to accommodate the actual data transmission rates for client systems corresponding to each client interface card. Solid bars 320 may represent the 100 Gbps bandwidth necessary to accommodate the 100 Gbps base data transmission rate of the client systems corresponding to each client interface card, while each cross-hatched bar 330 may represent 100 Gbps of additional bandwidth necessary to accommodate the data transmission above the base data transmission rate for the client systems corresponding to each client interface card.

The bandwidth requirements of a node may be reduced if the network is configured such that client interface cards may share universal transceivers for data transmissions exceeding the base data transmission rate of the client systems corresponding to each client interface card. Where client interface cards share universal transceivers, the node may provision bandwidth sufficient to accommodate the base data transmission rate of each client system and the peak data transmission rate of only a portion of the client systems. Thus, where universal transceivers are shared, only a portion of the client systems are permitted to simultaneously transmit at their peak data transmission rates.

FIG. 3B illustrates the bandwidth requirement of a node configured such that client interface cards may share universal transceivers for data transmissions exceeding the base data transmission rate of the client systems corresponding to each client interface card. To determine the bandwidth requirement of a node configured in this manner, it may be necessary to identify the number (N) of client systems permitted to simultaneously transmit at their peak data transmission rates. While it may be too optimistic to assume that all client systems in an optical communications network operate at their base data transmission rates, it may be too pessimistic to assume that all client systems operate at their peak data transmission rates. Instead, it may be assumed that data traffic is variable (e.g., some client systems operating at their peak data transmission rate, while others operate at their base data transmission rate).

Consider, for example, that only four of the eight client systems corresponding to the node illustrated in FIGS. 3A and 3B are permitted to simultaneously transmit at their peak data transmission rates of 400 Gbps (e.g., N=4), while the remaining client systems operate at their base data transmission rate of 100 Gbps. Each block 310 may represent the bandwidth required to accommodate a client system corresponding to a particular client interface card. Because only four of the eight client systems corresponding to the node are permitted to simultaneously transmit at their peak data transmission rate, only blocks 310A, 310C, 310E, and 310H are sized to represent the 400 Gbps of bandwidth necessary to accommodate the 400 Gbps peak data transmission rate of the corresponding client systems. The remaining blocks 310B, 310D, 310F, and 310G are sized to represent the 100 Gbps base data transmission rate of the corresponding client systems. A node configured in this manner may have a bandwidth requirement of 2000 Gbps.

Thus, as illustrated by comparing FIGS. 3A and 3B, a node configured to permit only a portion of the client systems corresponding with the node to simultaneously transmit at their peak data transmission rates may have a lower bandwidth requirement than that of a node configured to provision bandwidth sufficient to accommodate the peak data transmission rate of each client system. For example, the node illustrated in FIG. 3A may have a bandwidth requirement of 3200 Gbps, while the node illustrated in FIG. 3B may have a bandwidth requirement of 2000 Gbps.

Although the example client systems discussed in conjunction with in FIGS. 3A and 3B each have a base data transmission rate of 100 Gbps, the base data transmission rate of a client system may be greater than 100 Gbps. Additionally, the base and peak data transmission rates may vary among client systems. For example, as discussed in conjunction with FIG. 2, the client system corresponding to client interface card 210A has a peak data transmission rate of 400 Gbps, while the client system corresponding to client interface card 210B has a peak data transmission rate of 300 Gbps.

Further, although the example node discussed in conjunction with FIG. 3B was configured to permit four of the eight client systems corresponding with the node to simultaneously transmit at their peak data transmission rates, the number and or percentage of client systems permitted to simultaneously transmit at their peak data transmission rates may vary. Where a greater percentage of client systems are permitted to simultaneously transmit at their peak data transmission rates, the bandwidth requirements of the optical communications network will be greater and thus the statistical capacity gain will be lower. Where a lesser percentage of client systems are permitted to simultaneously transmit at their peak data transmission rates, the bandwidth requirements of the optical communications network will be lower and thus the statistical capacity gain will be higher.

The number (N) of client systems corresponding to a particular node that are permitted to operate at their peak data transmission rate may be chosen by a system administrator or system designer based on a study of the node and/or the optical communications network. For example, as the percentage of client systems permitted to simultaneously transmit at their peak data transmission rates is increased, node and/or network performance may decline (e.g., client systems may be blocked when attempting to operate at a data transmission rate above their base data transmission rate).

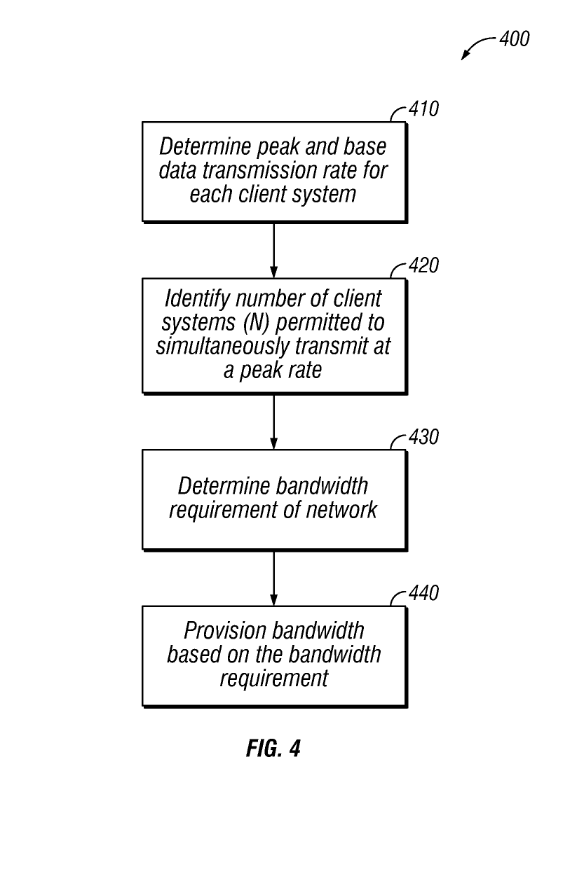

FIG. 4 is a flow chart of an example method 400 of statistical sharing in an optical communications network. As discussed above with respect to FIG. 2, some optical communications networks are configured such the bandwidth provisioned for each optical circuit is based on the peak anticipated bandwidth for the client systems corresponding to each circuit, even though the peak bandwidth is not always used. To increase the statistical capacity and/or reduce the required bandwidth, client interface cards may share universal transceivers for data transmissions exceeding the base data transmission rate of each corresponding client system. As discussed with respect to FIGS. 3A and 3B, where client interface cards share universal transceivers, a node may provision bandwidth sufficient to accommodate the base data transmission rate of the client systems corresponding to each client interface card and the peak data transmission rate of only a portion of the client systems corresponding to the client interface cards.

At step 410, the peak data transmission rate and the base data transmission rate for each client system may be determined. As discussed above in conjunction with FIG. 2, the base data transmission rate may be the rate at which data is routinely transmitted by the client system, and the peak data transmission rate may be the maximum rate at which data is transmitted by the client system.

At step 420, the number (N) of client systems permitted to simultaneously transmit at their peak data transmission rate may be identified. As discussed above with respect to FIG. 3B, the number (N) of client systems corresponding to a particular node that are permitted to operate at their peak data transmission rate may be chosen by a system administrator or system designer based on a study of the node and/or the optical communications network. For example, as the percentage of client systems permitted to simultaneously transmit at their peak data transmission rates is increased, node and/or network performance may decline (e.g., client systems may be blocked when attempting to operate at a data transmission rate above their base data transmission rate).

At step 430, the bandwidth requirement of the node may be determined. As discussed with respect to FIG. 3B, in a node in which only a portion of the client systems corresponding to the node are permitted to transmit at their peak rates, the bandwidth requirement of the node may be based on the number (N) of client systems permitted to transmit at their peak rates, as well as the peak and base data transmission rates of the client systems. Consider, for example, a node including eight client interface cards, each corresponding to a client system with a base data transmission rate of 100 Gbps and a peak data transmission rate of 400 Gbps. If only four of the eight client systems are permitted to simultaneously transmit at their peak data transmission rates (e.g., N=4), while the remaining four client systems operate at their base data transmission rate of 100 Gbps, the bandwidth requirement of the network may be equal to 2000 Gbps (4*peak data transmission rate of 400 Gbps+4*base data transmission rate of 100 Gbps).

Where the peak data transmission rates vary among client systems, the bandwidth must be sufficient to accommodate the peak data transmission rates of N client systems with the highest peak rates, as well as the base data transmission rates of the remaining client systems. Thus, in a system where N=4, bandwidth must sufficient to accommodate the four highest peak data transmission rates, as well as the base data transmission rates of the remaining client systems. In other words, the bandwidth requirement of such a system may equal the sum of the N highest peak data transmission rates and the remaining base data transmission rates.

At step 440, bandwidth may be provisioned based on the bandwidth requirement determined at step 430. Thus, the total bandwidth provisioned for a particular node may equal to the sum of the N highest peak data transmission rates of the client systems corresponding to the node plus the sum of the base data transmission rates for the remaining client systems corresponding to the node.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present invention have been described in detail, it should be understood that the various changes, substitutions, and alterations could be made hereto without departing from the spirit and scope of the invention.

What is claimed is:

1. A method of statistical sharing in an optical communications network, the method comprising:
identifying a peak transmission rate and a base transmission rate for each of a plurality of client interface cards of an optical node;
provisioning a set of universal transceivers of a plurality of universal transceivers for a particular client interface card of the plurality of client interface cards such that the combined bandwidth of the set of universal transceivers is greater than or equal to the base transmission rate of the particular client interface card; and
reserving one or more shared universal transceivers of the plurality of universal transceivers for the particular client interface card, when a transmission rate of the particular client interface card exceeds the base transmission rate of the particular client interface card.

2. The method of claim 1, the method further comprising releasing the one or more shared universal transceivers reserved for the particular client interface card, when the transmission rate of the particular client interface card is equal to or less than the base transmission rate of the particular client interface card.

3. The method of claim 1, the method further comprising:
identifying a number (N) of client interface cards of the plurality of client interface cards permitted to simultaneously transmit at the peak transmission rate; and
determining a bandwidth capacity of the optical node based at least on the base transmission rate of each of the plurality of client interface cards and the peak transmission rate of N client interface cards of the plurality of client interface cards.

4. The method of claim 3, wherein determining the bandwidth capacity comprises:
identifying a set of client interface cards of the plurality of client interface cards with the N highest peak transmission rates;
identifying a base transmission rate for each of the remaining client interface cards of the plurality of client interface cards; and
calculating the bandwidth capacity, the bandwidth capacity equal to the sum of the N highest peak transmission rates plus the sum of the base transmission rates for each of the remaining client interface cards.

5. The method of claim 1, wherein each universal transceiver of the plurality of universal transceivers is configured with a particular bandwidth.

6. An optical communications network comprising:
a cross-connect switch;
a plurality of universal transceivers communicatively coupled to the cross-connect switch;
a switching module communicatively coupled to the plurality of universal transceivers; and
a controller communicatively coupled to the cross-connect switch and the switching module, the controller configured to:
identify a peak transmission rate and a base transmission rate for each of a plurality of client interface cards of an optical node;
provision a set of universal transceivers of a plurality of universal transceivers for a particular client interface card of the plurality of client interface cards such that the combined bandwidth of the set of universal transceivers is greater than or equal to the base transmission rate of the particular client interface card; and
reserve one or more shared universal transceivers of the plurality of universal transceivers for the particular client interface card, when a transmission rate of the particular client interface card exceeds the base transmission rate of the particular client interface card.

7. The optical communications network of claim 6, wherein the controller is further configured to release the one or more shared universal transceivers reserved for the particular client interface card, when the transmission rate of the particular client interface card is equal to or less than the base transmission rate of the particular client interface card.

8. The optical communications network of claim 6, wherein the controller is further configured to:
identify a number (N) of client interface cards of the plurality of client interface cards permitted to simultaneously transmit at the peak transmission rate; and
determine a bandwidth capacity of the optical node based at least on the base transmission rate of each of the plurality of client interface cards and the peak transmission rate of N client interface cards of the plurality of client interface cards.

9. The optical communications network of claim 8, wherein determining the bandwidth capacity comprises:
identify a set of client interface cards of the plurality of client interface cards with the N highest peak transmission rates;
identify a base transmission rate for each of the remaining client interface cards of the plurality of client interface cards; and
calculate the bandwidth capacity, the bandwidth capacity equal to the sum of the N highest peak transmission rates plus the sum of the base transmission rates for each of the remaining client interface cards.

10. The optical communications network of claim 6, wherein the switching module is a reconfigurable optical add-drop multiplexer (ROADM) switch.

11. The optical communications network of claim 6, wherein each universal transceiver of the plurality of universal transceivers is configured with a particular bandwidth.

12. A non-transitory, computer-readable medium including computer-executable instructions encoded in the computer readable medium, the instructions, when executed by the processor, operable to perform operations comprising:
identifying a peak transmission rate and a base transmission rate for each of a plurality of client interface cards of an optical node;
provisioning a set of universal transceivers of a plurality of universal transceivers for a particular client interface card of the plurality of client interface cards such that the combined bandwidth of the set of universal transceivers is greater than or equal to the base transmission rate of the particular client interface card; and
reserving one or more shared universal transceivers of the plurality of universal transceivers for the particular client interface card, when a transmission rate of the particular client interface card exceeds the base transmission rate of the particular client interface card.

13. The computer-readable medium of claim 12, the computer executable instructions, when executed by the processor, further operable to perform operations comprising releasing the one or more shared universal transceivers reserved for the particular client interface card, when the transmission rate of the particular client interface card is equal to or less than the base transmission rate of the particular client interface card.

14. The computer-readable medium of claim 12, the computer executable instructions, when executed by the processor, further operable to perform operations comprising:
identifying a number (N) of client interface cards of the plurality of client interface cards permitted to simultaneously transmit at the peak transmission rate; and
determining a bandwidth capacity of the optical node based at least on the base transmission rate of each of the plurality of client interface cards and the peak transmission rate of N client interface cards of the plurality of client interface cards.

15. The computer-readable medium of claim 14, wherein determining the bandwidth capacity comprises:
identifying a set of client interface cards of the plurality of client interface cards with the N highest peak transmission rates;
identifying a base transmission rate for each of the remaining client interface cards of the plurality of client interface cards; and
calculating the bandwidth capacity, the bandwidth capacity equal to the sum of the N highest peak transmission rates plus the sum of the base transmission rates for each of the remaining client interface cards.

16. The computer-readable medium of claim 12, wherein each universal transceiver of the plurality of universal transceivers is configured with a particular bandwidth.
